(19) United States
(12) Patent Application Publication
(10) Pub. No.: US 2013/0015805 A1
(43) Pub. Date: Jan. 17, 2013

(54) ENERGY STORAGE ELEMENT LINK AND MONITOR

(71) Applicants: Ross Teggatz, McKinney, TX (US); Wayne Chen, Plano, TX (US); Justin Morris, McKinney, TX (US)

(72) Inventors: Ross Teggatz, McKinney, TX (US); Wayne Chen, Plano, TX (US); Justin Morris, McKinney, TX (US)

(73) Assignee: TRIUNE IP LLC, Richardson, TX (US)

(21) Appl. No.: 13/153,871

(22) Filed: Jun. 6, 2011

Related U.S. Application Data
(60) Provisional application No. 61/351,843, filed on Jun. 4, 2010.

(51) Int. Cl. H02J 7/00

(52) U.S. Cl. 320/101; 320/134; 320/118; 320/126; 320/117; 320/166; 320/167

(57) ABSTRACT

The invention provides an energy storage system having storage elements linked for collective charging and discharging. Monitoring circuitry is provided for monitoring each of the storage elements independently. Preferably, the system includes control circuitry configured for controlling the linking of individual storage elements in order to enhance system performance. In preferred embodiments, the system also includes storage elements in an arrangement whereby they may be selectably linked and delinked, in series, parallel, or in one or more series/parallel combination.

### PRIORITY ENTITLEMENT

This application is entitled to priority based on Provisional Patent Application Ser. No. 61/351,843, filed on Jun. 4, 2010, which is incorporated herein for all purposes by this reference. This application and the Provisional Patent Application have at least one common inventor.

### TECHNICAL FIELD

The invention relates to energy conservation and the development of renewable energy resources. In particular, the invention is directed to energy storage systems, and more particularly to battery systems employed in association with energy harvesting apparatus.

### BACKGROUND OF THE INVENTION

It is known in many applications to use batteries to supply power to a system and/or to store power harvested by a system. In many cases, the batteries eventually degrade and fail, often to the detriment of the system into which they are integrated. In some cases, not only are costs incurred for the replacement of the batteries and associated repairs to the system, but also for the loss of productivity of the system during the time that it is impaired or inoperable. In some systems it is cost-effective to simply replace the batteries upon obvious failure, but in larger systems such as systems for harvesting renewable energy for example, it can be problematic and/or costly to shut down the system and replace all of its batteries. In some of such cases, it would be beneficial to be aware of the progress of slow degradation of individual battery cells or battery systems as a whole, and especially of imminent failure(s).

Major battery construction types include flooded (also known as “wet”), gelled, and AGM (Absorbed Glass Mat). Each of these three battery types typically consists of a group of individual cells utilizing their respective technologies. Flooded batteries are uniquely disadvantaged in that they can leak and/or spill if subjected to physical damage. Gelled and AGM batteries are sealed and utilize suspended electrolytes designed to prevent hazardous spills. Batteries of whatever type are generally constructed of individual cells. Each of these cells, though designed for similar performance, are nevertheless inevitably somewhat variable in their charging and discharging characteristics. Similar to a chain and its links, a multi-cell battery as a whole is only as strong as its weakest cell. In turn, a battery bank consisting of multiple batteries is only as strong as its weakest battery since individual cells and batteries may be charged and/or discharged at different rates, or in some cases fail to charge and/or discharge altogether. Therefore, when a single battery cell degrades and/or fails completely, it can impair an entire bank of combined batteries. In this scenario, standard charging techniques generally used for charging all cells within a battery to the same charge level can severely damage internal components and chemistry of the other cells within the battery, ultimately causing complete failure. Generally, once an individual cell degrades significantly, the entire battery as a whole becomes less efficient and is destined for eventual failure.

Irrespective of battery type, problems also arise with regard to physical dimensions, weight, and other form factors. To cite a specific example, in remote renewable energy applications such as solar-powered street lamps, an example of which is shown in the system 10 depicted in FIG. 1 (prior art), providing a battery bank 12 presents a problem with regard to physical placement within the system 10. Placing the battery bank 10 on the upper-half 14 of the lamp post 16, as shown, poorly distributes a significant amount of battery weight, potentially hundreds of pounds, possibly leading to structural integrity problems with the lamp post 16. Also, placement of the batteries at an elevated location is often inconvenient for maintenance purposes. In some cases, battery placement may also require that the location of energy harvesting equipment, e.g., a photovoltaic array 18, be taken into account and accommodated as well. Placing the battery bank 12 on the bottom half of the lamp post 16 may be obscure the light produced by the lamps 18 to some extent, as well as exposing the batteries 12 to potential hazards such as theft, vandalism, allisions, and flooding. In either of these examples, batteries of fixed dimensions limit system design flexibility. The alternative of placing the battery bank on or below ground level is faced with the same or similar problems. In parking lot applications, for example, the drainage of rain water and safely venting gasses potentially emitted by the batteries are further examples of additional problems that may arise.

Due to these and other problems and potential problems, sophisticated energy storage element linking systems, monitors, and charging and discharging controls would be useful and advantageous contributions to the arts, as would improved battery bank systems.

### SUMMARY OF THE INVENTION

In carrying out the principles of the present invention, in accordance with preferred embodiments, the invention provides advances in the arts with novel approaches directed to energy conservation and development of renewable energy resources. Although energy storage elements are discussed herein in terms of batteries by way of example, similar problems and solutions generally also apply to other storage elements such as capacitors and super-capacitors and to combinations of storage elements such as arrays including batteries and/or capacitors, separately or in combination.

According to one aspect of the invention, an energy storage system in an example of a preferred embodiment includes storage elements linked for collective charging and discharging. A monitoring circuit is provided for monitoring each of the storage elements independently.

According to another aspect of the invention, in a presently preferred embodiment, an energy harvesting and storage system includes a system of energy storage elements connected with energy harvesting devices. The storage elements are interlinked for collective charging and discharging. A monitoring circuit is arranged to individually monitor each of the storage elements and to provide data to a control circuit for use in controlling the charging and discharging of the energy storage elements.

According to still another aspect of the invention, in examples of preferred embodiments, an energy storage system includes storage elements adapted to be selectably linked and delinked, in series, parallel, or in one or more series/parallel combination.

According to another aspect of the invention, in preferred embodiments, an energy storage system includes storage elements linked in a configuration such that any one storage element may be selectively bypassed from charging or discharging.

According to another aspect of the invention, energy storage systems in preferred embodiments include control circuitry configured for controlling the linking of individual storage elements in order to control overall system performance.

The invention has advantages including but not limited to one or more of the following, improved energy harvesting and/or storage element linking and monitoring, improved design flexibility, and reduced system costs. These and other advantageous features and benefits of the present invention can be understood by one of skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 (prior art) shows a representation of an energy harvesting and storage system known in the art;

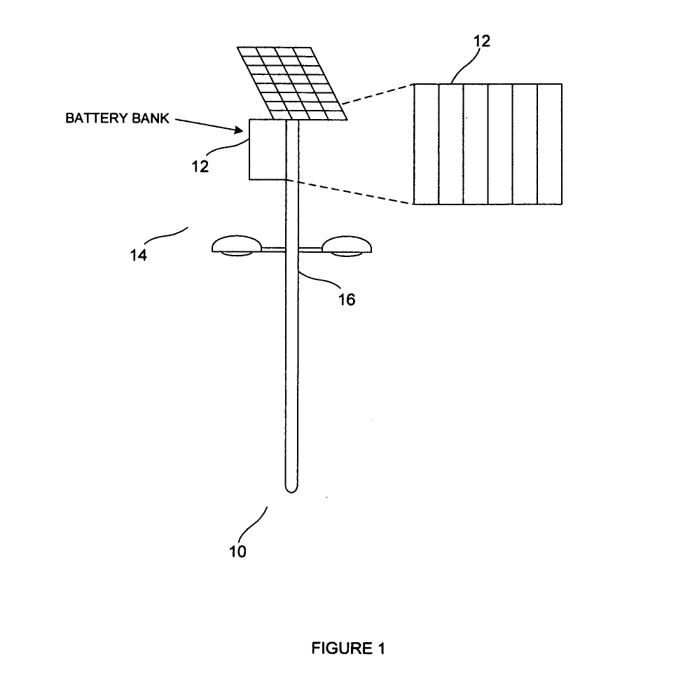

FIG. 2 is a simplified schematic diagram illustrating an example of preferred embodiments of circuits and systems according to the invention;

FIG. 3 is simplified schematic diagram illustrating a further example of preferred embodiments of circuits and systems according to the invention;

FIG. 4 is simplified schematic diagram illustrating an example of the deployment of preferred embodiments of circuits and systems according to the invention;

FIG. 5 is simplified schematic diagram illustrating an alternative example of preferred embodiments of circuits and systems according to the invention;

FIG. 6 is simplified schematic circuit diagram illustrating another example of preferred embodiments of circuits and systems according to the invention; and

FIG. 7 is simplified schematic circuit diagram illustrating another example of preferred embodiments of circuits and systems according to the invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as anticipated and unanticipated advantages of the invention.

### DESCRIPTION OF PREFERRED EMBODIMENTS

Preferred embodiments of systems for linking, monitoring, and preferably controlling, energy storage elements arranged in banks or arrays are described. Energy storage elements may include batteries or capacitors, which are known in the arts and may be considered interchangeable for the purposes of the exemplary embodiments shown and described herein. Battery, capacitor, switch and monitoring and controlling devices known in the arts may be used to provide the functionality and combinations within the framework of the invention.

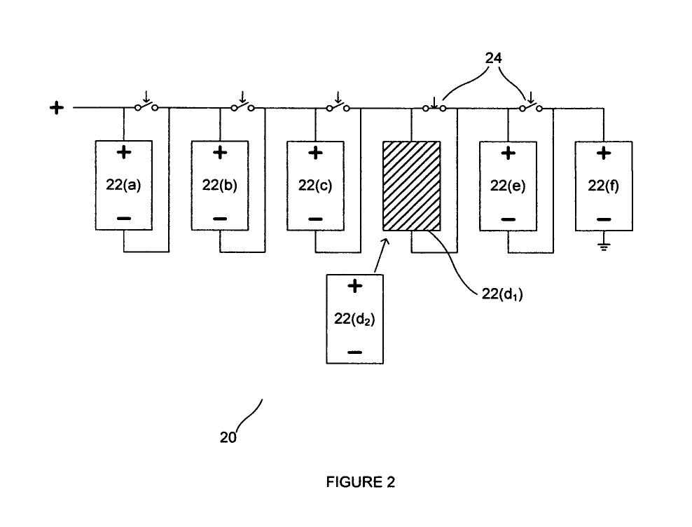

Referring to the conceptual overview of the storage element link and monitor system 20 depicted in FIG. 2, linking individual cells 22(a-f) together, as shown, allows for any individual cell to be replaced, e.g., removing cell 22(d₁) and replacing it with cell 22(d₂), in the event it exhibits unacceptable performance. This capability improves system integration, management, and maintenance of banks of batteries or other storage elements. Preferably, suitable switches 24 are provided in a configuration facilitating selectably linking storage elements 22 such that the switchable links may be used to bypass individual storage elements, as shown at cell 22(d) in this example. This arrangement provides the advantage inherent in enabling the bypassing, removal, and replacement of individual cells 22 without necessarily interrupting the operation of the system 20. Thus, a defective cell 22(d₁) may be bypassed while the system 20 continues to charge and/or discharge, improving system operation and avoiding potential damage to other cells which might otherwise be caused by a defective cell skewing the operation of the system to the detriment of the input and/or output of neighboring cells. Depending on the requirements of a particular application, individual cells within a system may be linked in series, as shown in FIG. 2, in parallel, or in series-parallel combinations, providing a battery bank (or array of additional or alternative storage elements) having flexible system configurations, voltage, amperage, and power characteristics.

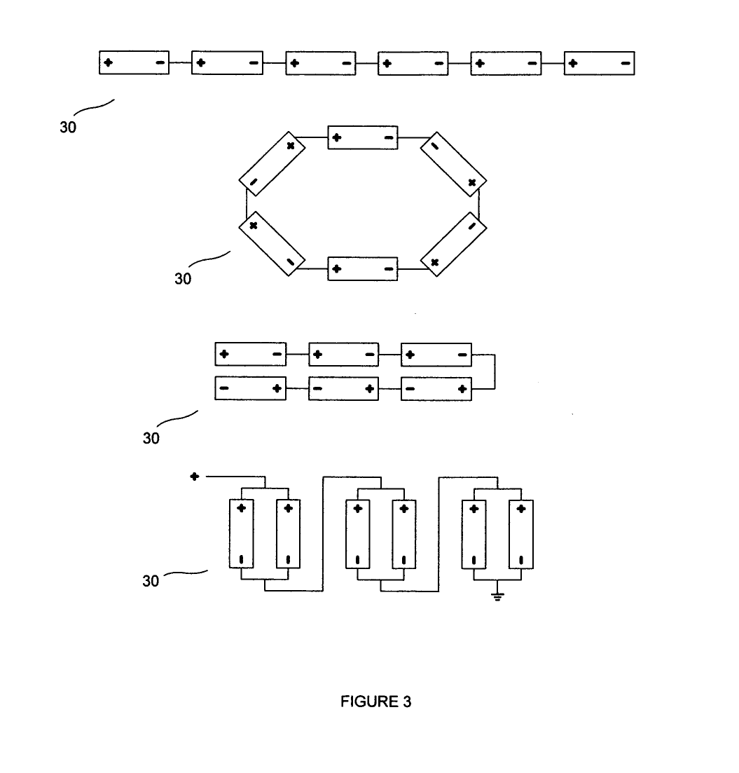

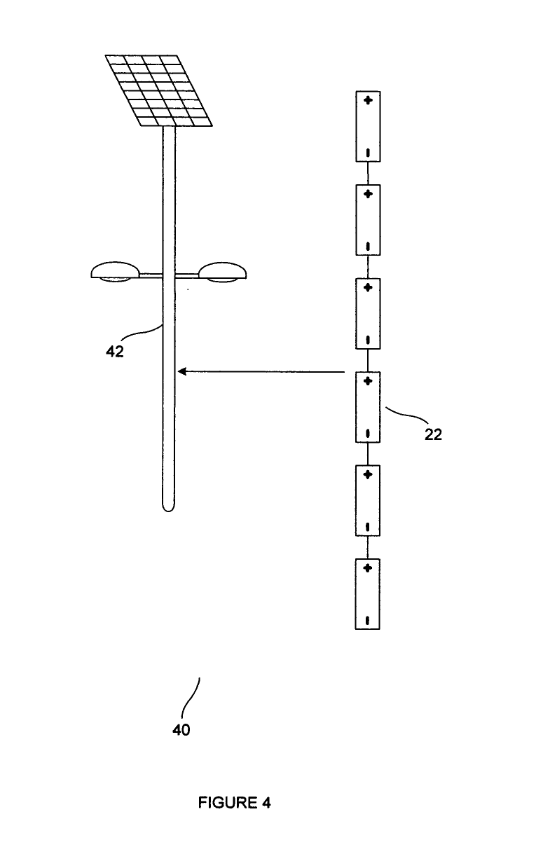

An example of various layouts which may be used within the scope of the invention is shown in the conceptual view of FIG. 3. Although all possible arrangements of storage element links cannot, and need not, be shown, exemplary configurations include series and parallel combinations 30 as shown. Additionally, it should be understood that a system having cells linked according to the invention facilitates deployment of the system in configurations adapted to accommodate various shapes. This is illustrated in the example of FIG. 4, in which a linked battery system 40 is shown deployed in a shape configured for accommodation within the confines of a lamp post 42. The linked storage elements of the invention may be used to adapt power storage element systems to various, shapes, volumes, weight distributions, and other physical limitations, thereby improving design flexibility in terms of form factor and circuit layout.

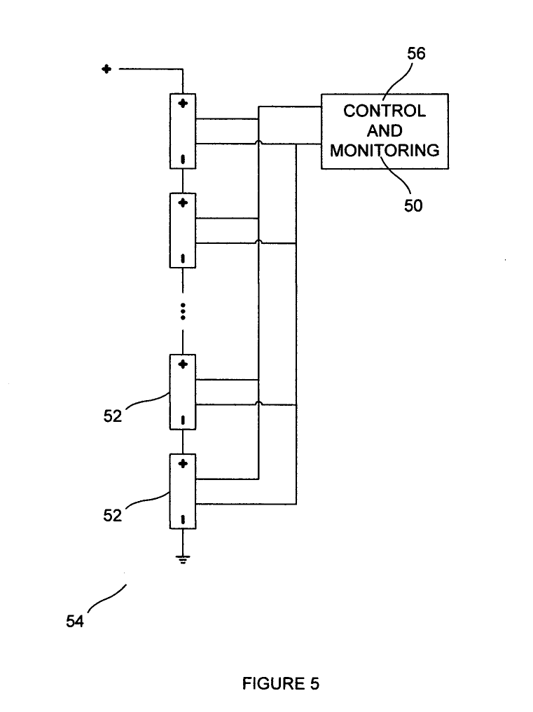

In order to fully realize the beneficial aspects of the switchable linking described, one or more monitoring circuit is preferably provided in order to monitor selected parameters potentially affecting the storage elements. As shown in FIG. 5, a monitoring circuit 50 is preferably connected to monitor each of the individual storage elements 52. The monitoring circuit 50 may be adapted to collect data with regard to parameters such as current, voltage, rate of charge/discharge, temperature and other electrical or other characteristics that may be useful for preventing damage to, or controlling the operation of the system of storage elements, e.g., battery bank 54, or the individual cells 52 of the storage element system. Preferably, one or more control circuit 56 is connected to the monitoring circuit 50 and is adapted to receive data from the monitoring circuit 50 in order to perform control functions relating to system operation according to monitored conditions. Monitoring circuits 50 and control circuits 56 may be utilized in a complimentary manner to maximize efficiency in performance, cell life, charging/discharging, maintenance, etc. Alternatively, individual monitor and control circuits may be provided at individual cells.

Preferably, in order to maximize efficiency and storage element life, each cell is consistently balanced properly, avoiding over- or under-charging. By monitoring each individual cell with a monitoring circuit, an associated control circuit may preferably be furnished with data reflecting the real-time performance of each cell, and may also be used to provide information to a user prior to, or upon, battery failure utilizing means such as WiFi, cellular, system display, LIN (Local Interconnect Network), and the like. The monitoring circuit is preferably equipped to identify any cell in the battery bank that is underperforming, preferably issuing an alert encouraging a user to replace the defective cell(s). The ability to identify the weak cell(s) in advance of failure is believed to reduce replacement and maintenance costs, as the weak cell(s) can be replaced prior to causing conditions which could potentially lead to permanently damaging the rest of the cells within the battery bank. In such cases, the monitoring circuit may detect and report conditions and the control circuit may accordingly adjust the charging and/or discharging parameters to enhance system performance according to dynamic conditions, and thereby diminish the likelihood of damage to additional system components. Monitored parameters may include, but are not necessarily limited to, storage element and load voltage and current, rate of charge, charge level, input power, and temperature, among others. Control functions may include, but are not limited to, increasing or decreasing charge and/or discharge voltage and/or current, responding to upper and/or lower temperature thresholds, bypassing individual cells, and transmitting and/or receiving data and/or alerts to users or associated equipment.

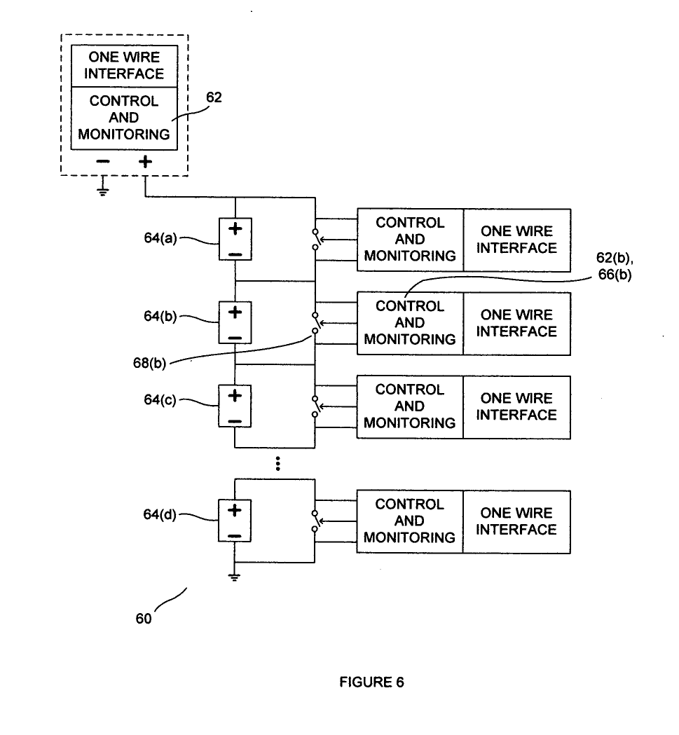

As illustrated in FIG. 6, in a system 60, in the event it is discovered using the monitoring circuit 62 that a particular cell 64(b) is deficient or potentially hazardous to the system in some way, the cell 64(b) may be bypassed by the control circuit 66(b) causing switch 68(b) to close. In this manner the system 60 may continue to operate without the defective cell 62(b), and/or a user alert may be provided for initiating replacement of the defective cell. Following replacement of the defective cell, the monitoring and control circuits may be manually reset.

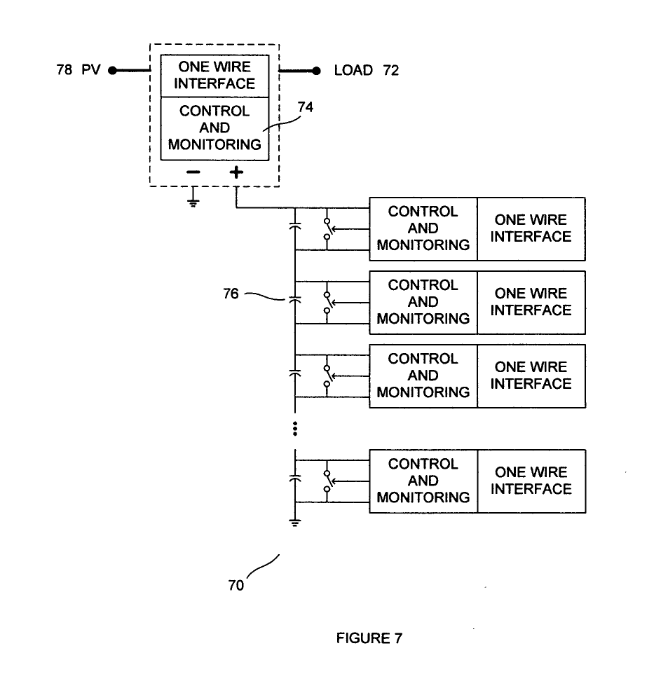

In general, overall system performance may be controlled according to user-selected criteria. Performance goals generally fall into several categories, including, but not limited to: maximization of storage element output current; maximization of storage element output voltage; maximization of storage element charging current; maximization of storage element charging voltage; avoidance of potentially damaging temperature extremes. FIG. 7 shows the deployment of a system 70 depicting alternative embodiments. The connection of a load 72 is shown to ensure that it is understood that the control circuit 74 may be used to control the allocation of charging or discharging power among the storage elements 76, in this case capacitors 76, and one or more load(s) 72. Energy harvesting apparatus 78 may also be included in the system 70, and may be monitored and controlled in the manner described. Energy harvesting elements which may be used to provide charging power may include, but are not limited to, photovoltaics, piezoelectric, and other electromechanical apparatus adapted to convert mechanical energy into electrical energy, such as wind or water turbines or regenerative braking apparatus.

It should be appreciated that data related to system operation collected by monitoring circuits may be transmitted to external locations, as well as internally, using suitable communications devices known in the arts. Thus, external commands and/or data may preferably also be relayed to the system and its control circuit(s). Such commands may include charging/discharging and/or other operational parameters directed to applicable components within the system, such as storage elements, energy harvesting devices, switches, etc. Data and command may be transmitted, received, and distributed throughout the system using a single wire as shown in the figures. The link(s) between the cells preferably carry charging/discharging current as well as data and commands related to system and component performance.

While the making and using of various exemplary embodiments of the invention are described and illustrated herein, it should be appreciated that the present invention provides inventive concepts which can be embodied in a wide variety of specific contexts. It should be understood that the invention may be practiced with energy harvesting and storage element technology in various forms of implementation. For purposes of clarity, detailed descriptions of functions, components, and systems familiar to those skilled in the applicable arts are not included. The systems and apparatus of the invention provide one or more advantages including but not limited to, improved energy storage element linking and monitoring. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. An energy storage system comprising:
a plurality of storage elements linked for collective charging and discharging in a configuration such that any one storage element may be selectably bypassed; and
a monitoring circuit operably coupled for individually monitoring each of the storage elements.

2. The energy storage system according to claim 1 wherein the monitoring circuit further comprises control circuitry.

3. The energy storage system according to claim 1 wherein the monitoring circuit further comprises performance data collection circuitry.

4. The energy storage system according to claim 1 wherein the monitoring circuit further comprises a single-wire interface.

5. The energy storage system according to claim 1 wherein the storage elements are linked in series.

6. The energy storage system according to claim 1 wherein the storage elements are linked in parallel.

7. The energy storage system according to claim 1 wherein the storage elements are linked in series and parallel.

8. The energy storage system according to claim 1 wherein the storage elements are linked in a configuration whereby the storage elements may selectably be linked in series, parallel, or in one or more series/parallel combination.

9. The energy storage system according to claim 1 wherein the control circuitry is configured for controlling charging of individual storage elements.

10. The energy storage system according to claim 1 wherein the control circuitry is configured for controlling discharging of individual storage elements.

11. The energy storage system according to claim 1 wherein the control circuitry is configured for transmitting data relating to individual storage elements.

12. The energy storage system according to claim 1 wherein the control circuitry is configured for receiving data relating to individual storage elements.

13. The energy storage system according to claim 1 wherein the control circuitry is configured for controlling the linking of individual storage elements whereby it controls overall system performance.

14. The energy storage system according to claim 1 wherein the storage elements comprise batteries.

15. The energy storage system according to claim 1 wherein the storage elements comprise capacitors.

16. An energy harvesting system comprising:
one or more energy harvesting devices for generating electrical energy;
a plurality of storage elements operably coupled to the one or more energy harvesting devices, the individual storage elements interlinked for collective charging and discharging in a configuration such that any one storage element may be bypassed; and
a monitoring circuit operably coupled for individually monitoring each of the storage elements.

17. The energy harvesting system according to claim 16 wherein the control circuitry is configured for controlling discharging of individual storage elements.

18. The energy harvesting system according to claim 16 wherein the monitoring circuit further comprises performance data collection circuitry.

19. The energy harvesting system according to claim 16 wherein the monitoring circuit further comprises a single-wire interface.

20. The energy harvesting system according to claim 16 wherein the storage elements are linked in series.

21. The energy harvesting system according to claim 16 wherein the storage elements are linked in parallel.

22. The energy harvesting system according to claim 16 wherein the storage elements are linked in series and parallel.

23. The energy harvesting system according to claim 16 further comprising linking storage elements whereby the storage elements may selectably be linked in series, parallel, or in one or more series/parallel combination.

24. The energy harvesting system according to claim 16 wherein the control circuitry is configured for controlling charging of individual storage elements.

25. The energy harvesting system according to claim 16 wherein the control circuitry is configured for controlling discharging of individual storage elements.

26. The energy harvesting system according to claim 16 wherein the control circuitry is configured for transmitting data relating to individual storage elements.

27. The energy harvesting system according to claim 16 wherein the control circuitry is configured for receiving data relating to individual storage elements.

28. The energy harvesting system according to claim 16 wherein the control circuitry is configured for controlling the linking of individual storage elements whereby it controls overall system performance.

29. The energy harvesting system according to claim 16 wherein the energy harvesting devices comprise photovoltaics.

30. The energy harvesting system according to claim 16 wherein the energy harvesting devices comprise wind energy harvesting devices.

31. The energy harvesting system according to claim 16 wherein the energy harvesting devices comprise piezoelectric devices.

32. The energy harvesting system according to claim 16 wherein the energy harvesting devices comprise electromechanical energy conversion devices.
